(19) United States
(12) Patent Application Publication
(10) Pub. No.: US 2016/0301770 A1
(43) Pub. Date: Oct. 13, 2016

(54) SYSTEMS AND METHODS FOR PREDICTING BANDWIDTH TO OPTIMIZE USER EXPERIENCE

(71) Applicant: Facebook, Inc., Menlo Park, CA (US)

(72) Inventors: Christopher John Marra, San Francisco, CA (US); Daniel Webster Weaver, Redwood City, CA (US); Tomas Kabbabe Sfeir, San Francisco, CA (US); Alexandru Petrescu, Shoreline, WA (US)

(21) Appl. No.: 14/683,761

(22) Filed: Apr. 10, 2015

(51) Int. Cl. H04L 29/08; H04L 12/24

(52) U.S. Cl. CPC H04L 67/327; H04L 41/0896; H04L 67/1074

(57) ABSTRACT

Systems, methods, and non-transitory computer-readable media can determine a predicted bandwidth value for communications between a first computing system and a second computing system associated with a user of the first computing system. The first computing system can categorize the predicted bandwidth value into a connection quality class of a plurality of connection quality classes. The first computing system can customize provision of information from the first computing system to the second computing system based on the connection quality class.

### FIELD OF THE INVENTION

The present technology relates to the field of network communications. More particularly, the present technology relates to techniques for predicting bandwidth.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Ideally, the bandwidth of a communication link between the social networking system and a computing device associated with a user should be consistent with data requirements for the delivery of content. For example, when the amount of data to be delivered at a given time is relatively large, the bandwidth should be relatively high. When the amount of data to be delivered at a given time is relatively small, the bandwidth can be relatively low. When bandwidth does not match data requirements for the delivery of content, user experience can be impacted.

### SUMMARY

Various embodiments of the present disclosure can include systems, methods, and non-transitory computer readable media configured to determine a predicted bandwidth value for communications between a first computing system and a second computing system associated with a user of the first computing system. The first computing system can categorize the predicted bandwidth value into a connection quality class of a plurality of connection quality classes. The first computing system can customize provision of information from the first computing system to the second computing system based on the connection quality class.

In an embodiment, the determination of a predicted bandwidth value for communications further comprises dividing a first block of data into a plurality of chunks, at least a portion of the plurality of chunks to be transmitted to the second computing system before a second block of data. Bandwidth values associated with the at least a portion of the plurality of chunks can be determined. The determined bandwidth values associated with the at least a portion of the plurality of chunks can be averaged to determine the predicted bandwidth value.

In an embodiment, the categorization of the predicted bandwidth value is performed before transmission of the second block of data.

In an embodiment, the determination of a predicted bandwidth value for communications further comprises identifying at least one block of data transmitted between the first computing device and the second computing device. Bandwidth values associated with the at least one block of data can be determined. The determined bandwidth values associated with the at least one block of data can be averaged to determine the predicted bandwidth value.

In an embodiment, the determination of a predicted bandwidth value for communications further comprises discarding a block of data that does not satisfy a threshold data size before the averaging the determined bandwidth values.

In an embodiment, the determination of a predicted bandwidth value for communications further comprises applying a decay function to at least one determined bandwidth value before the averaging the determined bandwidth values.

In an embodiment, the determination of a predicted bandwidth value for communications comprises creating a latency mapping between round trip time associated with the first computing system and the second computing system and historical bandwidth values. The predicted bandwidth value can be determined based on the latency mapping.

In an embodiment, the determination of a predicted bandwidth value for communications comprises creating a radio mapping between at least one type of communication link associated with communications between the first computing system and the second computing system and historical bandwidth values. The predicted bandwidth value can be determined based on the radio mapping.

In an embodiment, each connection quality class of the plurality of connection quality classes can be associated with a unique range of bandwidth values.

In an embodiment, the first computing system can be associated with a social networking system and the second computing system can be associated with a user of the social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example connection quality module, according to an embodiment of the present disclosure.

FIG. 2 illustrates an example bandwidth determination module, according to an embodiment of the present disclosure.

FIG. 3 illustrates an example bandwidth module, according to an embodiment of the present disclosure.

FIG. 4 illustrates an example data transmission, according to an embodiment of the present disclosure.

FIG. 5 illustrates an example method, according to an embodiment of the present disclosure.

FIG. 6 illustrates an example method, according to an embodiment of the present disclosure.

FIG. 7 illustrates a network diagram of an example system including an example social networking system that can be utilized in various scenarios, according to an embodiment of the present disclosure.

FIG. 8 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Bandwidth Value Prediction

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (i.e., a social networking service, a social network, etc.). For example, users can provide, post, or publish content items, such as text, notes, status updates, links, pictures, videos, and audio, via the social networking system. Users also can access and experience content of almost every variety of type and form. The amount of data to be provided by a social networking system to a user can depend on content selected for presentation to the user.

The amount of data to be provided at particular time by a social networking system to a user can vary. When the amount of data to be provided is relatively small, only a relatively low bandwidth of a communication link between the social networking system and a computing device associated with the user can be needed. When the amount of data to be provided is relatively large, a relatively high bandwidth of a communication link can be desirable. Bandwidth can vary independently from content delivery preferences of a social networking system. When bandwidth does not match such preferences, user experience can be impacted. If bandwidth can be known in advance, the social networking system can plan the delivery of data to account for variable bandwidth while optimizing user experience. Unfortunately, however, it can be difficult to determine bandwidth in advance.

Therefore, an improved approach can be beneficial for addressing or alleviating various concerns associated with conventional approaches. The disclosed technology can provide a prediction of bandwidth values for a computing device associated with a user of a social networking system. The prediction of a bandwidth value can be based on a moving average of historical (or observed) bandwidth values. The historical bandwidth values can be associated with blocks of data having a threshold size, or portions (or chunks) of a block of data. A bandwidth value can be determined based on a data size of a block of data or relevant portions thereof and a transmission time for delivery of the data from the social networking system to the computing device. A time decay can be applied to the bandwidth values to decrease the importance of old values or increase the importance of new values. In some instances, a prediction of bandwidth values can be based on a mapping of latency values and historical bandwidth values or a mapping of types of communication links to historical bandwidth values. The predicted bandwidth value can be determined continuously or periodically. After a predicted bandwidth value is determined, the predicted bandwidth value can be categorized into one or more connection quality classes based on the predicted bandwidth value.

The categorization of a predicted bandwidth value into a connection quality class can allow the social networking system to more simply adapt its communications with the computing device based on the class. Such adaption can include customizing the operation of the social networking system based on the class. The presentation of content by the social networking system and other functionality performed by the social networking system can be tailored to the class of the predicted bandwidth value. For example, when future bandwidth is predicted to be relatively low, the social networking system or the computing device can determine that data potentially desired by the user should be provided to the computing device in advance so that user experience is not impacted by undue delay. While a social networking system in particular is sometimes referenced herein as an example, the present disclosure can apply to predict bandwidth values in connection with communications involving any other type of system.

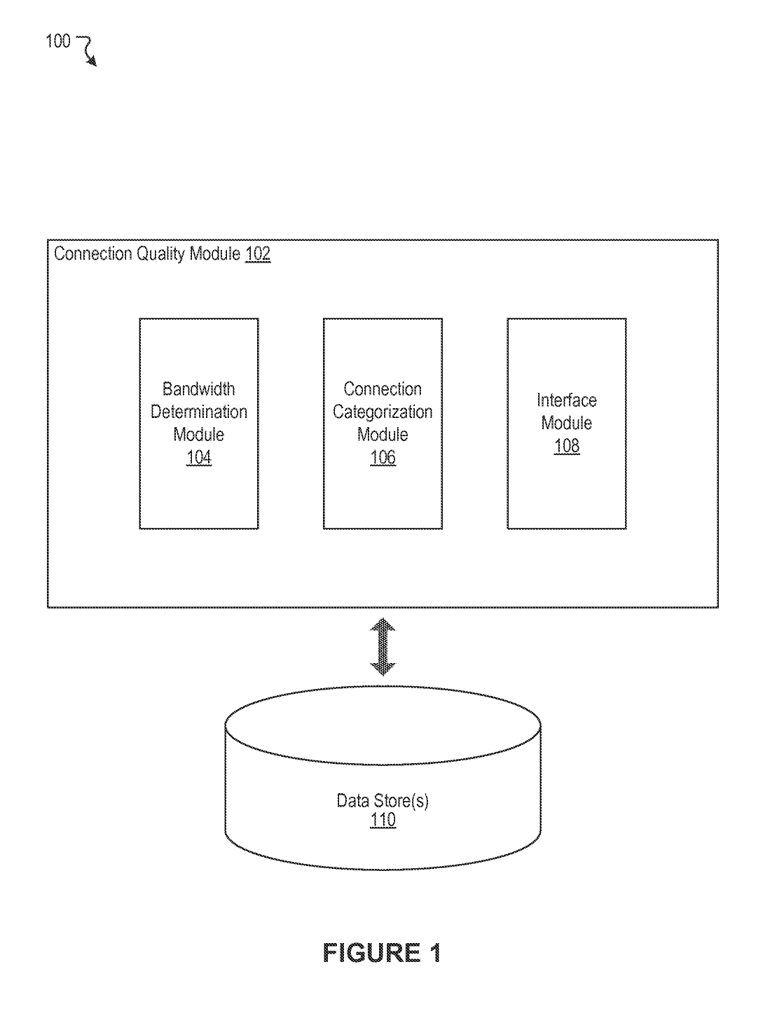

FIG. 1 illustrates an example system 100 including an example connection quality module 102 configured to predict a bandwidth value for communications between a system, such as a social networking system, and a computing device associated with a user of the system, according to an embodiment of the present disclosure. As shown in the example of FIG. 1, the connection quality module 102 can include a bandwidth determination module 104, a connection categorization module 106, and an interface module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. Although the system of the present disclosure is sometimes discussed herein with respect to a social networking system as an example, the present disclosure can be applied to any other type of system.

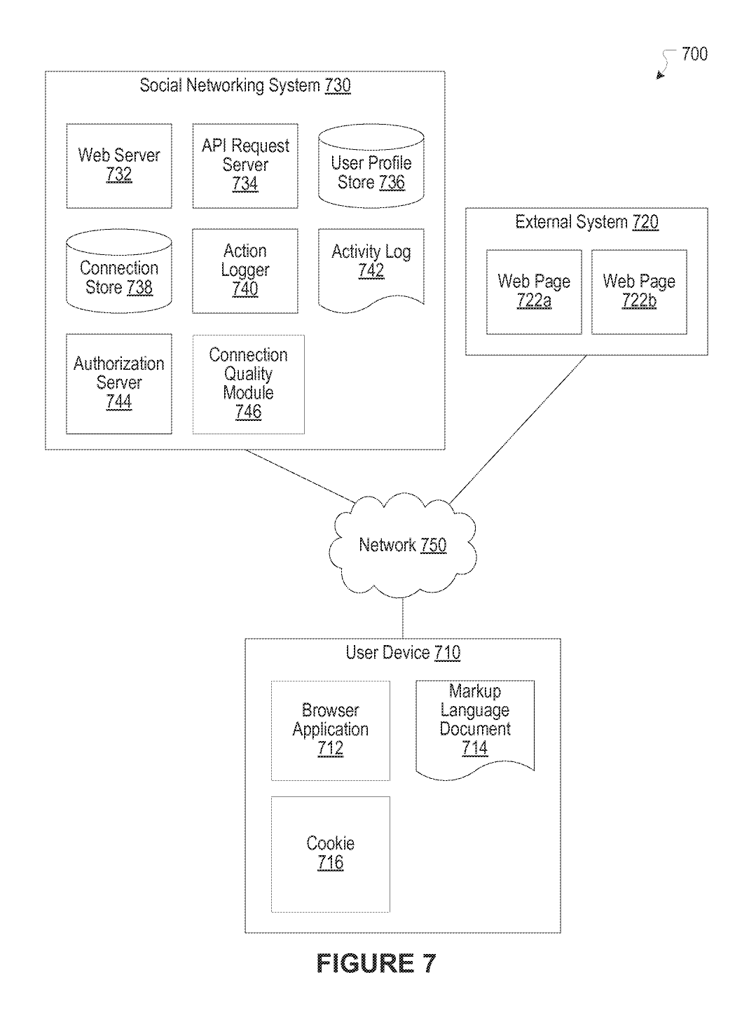

The connection quality module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the connection quality module 102 can be implemented, in part or in whole, as software running on one or more computing devices or systems, such as on a server computing system or a user (or client) computing system. For example, the connection quality module 102 or at least a portion thereof can be implemented as or within an application (e.g., app), a program, or an applet, etc., running on a user computing device or a client computing system, such as the user device 710 of FIG. 7. In another example, the connection quality module 102 or at least a portion thereof can be implemented using one or more computing devices or systems that include one or more servers, such as network servers or cloud servers. In some instances, the connection quality module 102 can, in part or in whole, be implemented within or configured to operate in conjunction with a social networking system (or service), such as the social networking system 730 of FIG. 7. It should be understood that there can be many variations or other possibilities.

Furthermore, in some embodiments, the connection quality module 102 can be configured to communicate and/or operate with at least one data store 110, as shown in the example system 100. The data store 110 can be configured to store and maintain various types of data. In some implementations, the data store 110 can store information associated with the social networking system (e.g., the social networking system 730 of FIG. 7). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the connection quality module 102. For instance, the data store 110 can store records relating to the size of data blocks, the size of portions (chunks) of data blocks, transmission time of the data blocks and the portions of data blocks, historical bandwidth values associated with data blocks and portions of data blocks, latency values, mappings of round trip times and bandwidth values, bandwidth values for types of communication links, mappings of types of communication links and bandwidth values, and other information needed by the connection quality module 102. It is contemplated that there can be many variations or other possibilities.

The bandwidth determination module 104 can be configured to determine predicted bandwidth values of a communication link between a social networking system and a computing device associated with a user. The determination of predicted bandwidth values can be based on various techniques that can be utilized individually or in suitable combinations. In one technique, a moving average of historical bandwidth values associated with communications between the social networking system and the computing device can be calculated. In another technique, a predicted bandwidth value can be based on historical bandwidth values relating to latency values associated with communications between the social networking system and the computing device. In yet another technique, a predicted bandwidth value can be based on historical bandwidth values relating to the type of communication link supporting communications between the social networking system and the computing device. The bandwidth determination module 104 is described in more detail herein.

The connection categorization module 106 can be configured to categorize a predicted bandwidth value into one of a plurality of connection quality classes. The categorization of bandwidth values into connection quality classes can help to facilitate and simplify accommodations or measures to enhance user experience based on bandwidth considerations. In some embodiments, the connection quality classes can be quantitatively defined by ranges of bandwidth values. Connection quality classes can divided into any suitable number of classes. For example, connection quality classes can be divided into four classes corresponding to four unique ranges of bandwidth values. In this example, a first range can correspond to a range of highest bandwidth values, a second range can correspond to a range of next highest bandwidth values below the bandwidth values of the first range, a third range can correspond to a range of next highest bandwidth values below the bandwidth values of the second range, and a fourth range can correspond to a range of next highest bandwidth values below the bandwidth values of the third range. Further, in this example, the first range can be identified as “excellent”, the second range can be identified as “good”, the third range can be identified as “moderate”, and the fourth range can be identified as “poor”. In other embodiments, any number of suitable connection quality classes (e.g., two, five, ten, etc.) can be used and any suitable identifiers for each class can be used. The connection quality module 102 can optimize user experience based on predicted bandwidth value and its associated connection quality class.

The interface module 108 can be configured to provide an interface to the connection quality module 102 to allow other services to use the connection quality module 102. The predicted bandwidth value and associated connection quality class can be used by the social networking system or other systems or services to optimize user experience associated with the computing device for which bandwidth has been predicted. In some instances, the interface module 108 can be implemented as a service that can be accessed by an API from within or outside the social networking system.

Many applications can leverage the functionality of the connection quality module 102 through the interface module 108. In some embodiments, a social networking system may desire to know the connection quality class of a computing device associated with a user of the social networking system to optimize user experience. For example, the quality of connections over cellular networks can vary significantly and, by knowing available connection qualities associated with users, the social networking system can deliver modified but still optimal experiences even when connection qualities are relatively low. For example, when a user enjoys a relatively high connection quality (or fast connection), the social networking system can provide high resolution images whereas providing a user a high resolution image when a user enjoys a relatively low connection quality (or slow connection) would cause poor user experience. Accordingly, the social networking system can use bandwidth to tune various services that involve the delivery of various types of data (e.g., images, video, other content, etc.), such as feed and messaging. For example, if the social networking system has predicted that the connection quality class of the computing device associated with the user is “poor” during a relevant time interval, the social networking system may choose to download an image having a relatively lower resolution in view of the relatively slow bandwidth that has been predicted. If the social networking system attempts to download an image having a relatively higher resolution in view of the relatively slow bandwidth that has been predicted, user experience could suffer in terms of undue downloading delay at least.

A social networking system can take other proactive measures based on predicted bandwidth and associated connection quality class. In some instances, if the connection quality class of a computing device of a user during a relevant time period is predicted to be “poor”, certain information that could be selected for download by the user can be downloaded in advance so that user experience is not unduly compromised. For example, the comments field of a news feed presented by the social networking system can be voluminous in terms of data size. Accordingly, if a user is expected to access the comments field of a news feed, the social networking system can download in advance (or prefetch) all necessary or background information to present the comments field so that the user can avoid delay at the moment when she chooses to view the comments field. Inversely, if the connection quality class of a computing device of a user at a relevant time is predicted to be “good” or “excellent”, the social networking system may choose not to download in advance (or prefetch) necessary or background information to present the comments field because a contemporaneous response to a selection by the user to view the comments field will be sufficiently fast to avoid delay.

The social networking system can take other action in response to a prediction of connection quality class. In some instances, if the connection quality class of a computing device of a user during a relevant time period is predicted to be “poor”, the social networking system can determine that, when content (e.g., video) is to be presented to the user for potential consumption, the content should not auto play so as to economize on bandwidth usage. Similarly, if the connection quality class of a computing device of a user during a relevant time period is predicted to be “poor”, the social networking system accordingly can modify, for example, the format of a story to be presented to the user, the depth of a horizontal scroll by the user, and the network prioritization queue so that user experience is optimized in view of the connection quality class. In other instances, if the connection quality class of a computing device of a user during a relevant time period is predicted to be “poor”, a type ahead feature of the social networking system can be adjusted to decrease the frequency of transmissions between the computing device and the social networking system because the predicted bandwidth will preclude effective use of the feature. In still other instances, if the connection quality class of a computing device of a user during a relevant time period is predicted to be “poor” or “moderate”, the social networking system can choose to route a request from the computing device to a server that is geographically closer to speed the response and accordingly enhance user experience. In still other instances, the prediction of connection quality class also can be used by the social networking system to perform analytics and testing to improve the performance of the social networking system in view of bandwidth determinations in different contexts. In addition, the social networking system can determine that network carriers are throttling certain users when the social networking system determines that predicted bandwidth is relatively high but actual bandwidth is relatively low. This bandwidth divergence can occur, for example, when a user has exceeded data limits assigned to her.

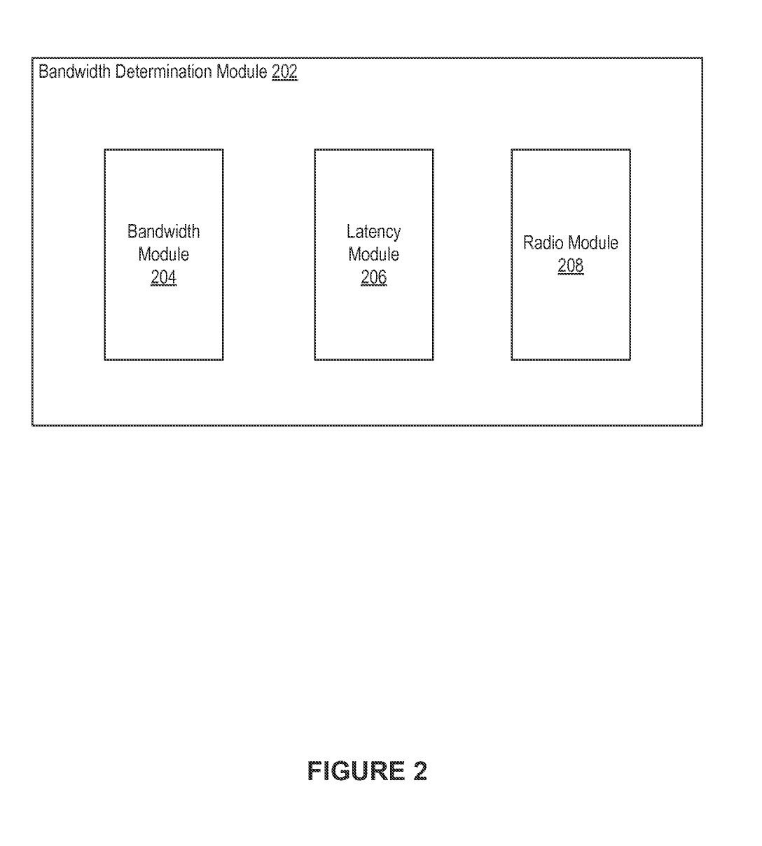

FIG. 2 illustrates an example bandwidth determination module 202 configured to predict bandwidth values relating to communications between a social networking system and a computing device associated with a user, according to an embodiment of the present disclosure. In some embodiments, the bandwidth determination module 104 of FIG. 1 can be implemented as the example bandwidth determination module 202. As shown in FIG. 2, the bandwidth determination module 202 can include a bandwidth module 204, a latency module 206, and a radio module 208. The bandwidth module 204, the latency module 206, and the radio module 208 can be used individually or in any selected combination to predict a bandwidth value.

The bandwidth module 204 can be configured to determine predicted bandwidth values based on a moving average of historical bandwidth values relating to communications between the social networking system and the computing device. The bandwidth module 204 is described in more detail herein.

The latency module 206 can be used to predict a bandwidth value. The latency module 206 can determine latency data based on a round trip time (RTT) between a social networking system and a computing device associated with a user. The latency module 206 can create a latency mapping between historical round trip times and associated bandwidth values. Based on a determination of round trip time, the latency module 206 can determine a predicted bandwidth value based on the mapping between historical round trip times and associated bandwidth values. For example, if a predicted bandwidth value is sought by a social networking system for a computing device associated with a user, a latency check can be performed between the social networking system and the computing device to determine a round trip time. Based on the latency mapping, the determined round trip time can be associated with a predicted bandwidth value. In some embodiments, the latency module 206 can be used to determine a predicted bandwidth value in the absence of suitable bandwidth values determined by the bandwidth module 204. In some embodiments, the latency mapping can be used to predict bandwidth values when a user is running a browser to access the social networking system instead of an application supported by the social networking system.

The radio module 208 can be used to predict a bandwidth value. The radio module 208 can create a radio mapping between types of communication links and associated historical bandwidth values for the types of communication links. Types of communication links can reflect the communication protocols and technologies on which communications between a social networking system and a user are supported. The types of communication links can include, for example, personal area networks (e.g., Bluetooth, Wireless USB, etc.), wireless local area networks (e.g., Wi-Fi, etc.), and wide area networks (e.g., GSM, EV-DO, W-CDMA, HSPA+, WIMAX, LTE, etc.). In some embodiments, the radio mapping also can account for network related IDs (e.g., operator ID, system ID, network ID, base station ID) in associating types of communication links with historical bandwidth values. Based on the detection of a type of communication link, the radio module 208 can predict a bandwidth value based on the radio mapping. For example, if a predicted bandwidth value is sought by a social networking system for a computing device associated with a user, the type of communication link supporting communications between the social networking system and the computing device can be determined. Based on the radio mapping, the determined type of communication link can be associated with a predicted bandwidth value. In some instances, the radio mapping can reflect historical bandwidth values experienced by a computing device of a particular user. In other instances, the radio mapping can reflect historical bandwidth values experienced by computing devices over a plurality of users. In some embodiments, the radio module 208 can be used to determine a predicted bandwidth value in the absence of suitable bandwidth values determined by the bandwidth module 204 and the latency module 206.

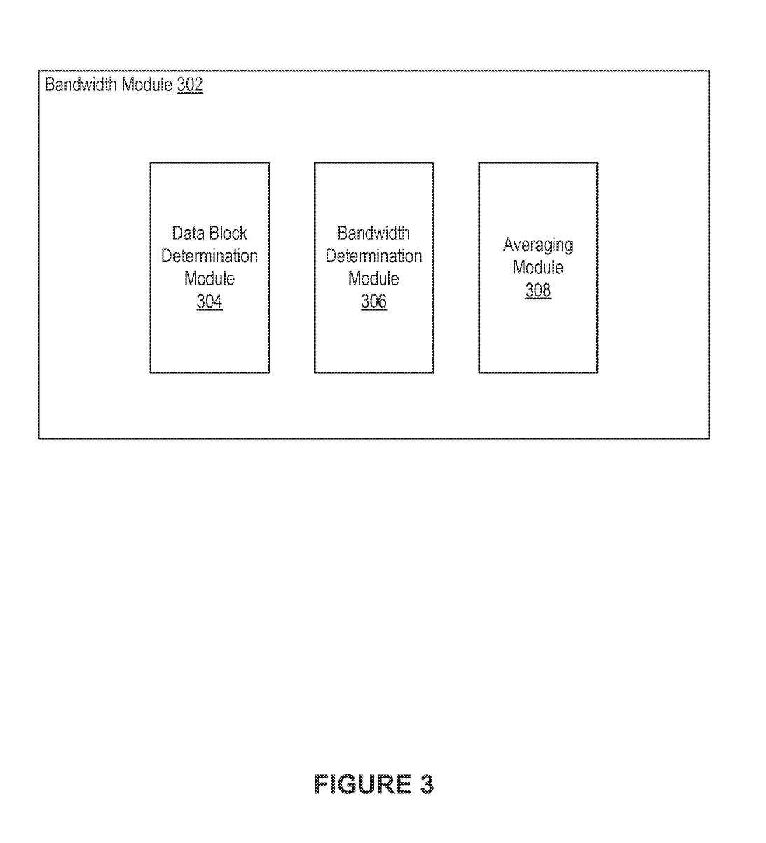

FIG. 3 illustrates an example bandwidth module 302 to determine predicted bandwidth values based on a moving average of historical bandwidth values relating to communications between a social networking system and a computing device associated with a user. In some embodiments, the bandwidth module 204 of FIG. 2 can be implemented as the example bandwidth module 302. The bandwidth module 302 can include a data block determination module 304, a bandwidth determination module 306, and an averaging module 308.

The block transmission determination module 304 can determine blocks of data that have been transmitted from the social networking system to the computing device. In some instances, a block of data has been provided to the computing device based on interactions of the user with the social networking system. For example, the block of data can be some portion or all of the data associated with content that the user has selected for download. The content can be one or more of, for example, an image, a video, audio, text, a screen, etc.

In some embodiments, the block determination module 304 can apply a threshold size filter to each identified block of data. Determinations of bandwidth value can be less reliable when based on relatively small amounts of data that are transmitted over a communication link. Accordingly, a threshold size filter can discard blocks of data that fail to satisfy a threshold data size. Such blocks of data can be discarded so that determinations of average bandwidth value by the connection quality module 102 do not account for unreliable bandwidth determinations associated with such blocks of data. The threshold size filter can be based on any suitable data size (e.g., 8K bytes) that provides a high confidence level for a determination of bandwidth value for a block of data.

In some embodiments, the bandwidth determination module 306 can determine bandwidth values based on blocks of data identified by the block determination module 304. In some instances, the bandwidth determination module 306 can perform calculations of bandwidth values based on blocks of data that are not discarded after application of the threshold size filter by the data block determination module 304. The bandwidth determination module 306 can receive information about transmission time of a block of data from the social networking system to the computing device. The transmission time of the block of data can be provided by an application running on the computing device. Timing resources, such as one or more clocks, can be synchronized between the social networking system and the application (or an operating system of the computing device on which the application runs) so that accurate timing information can be obtained regarding the transmission time of a block of data. The determination of a bandwidth value of a block of data can be based on the size of the block of data and the transmission time of the block of data. The size of the block of data and the transmission time of the block of data can be maintained in the data store 110. In this manner, the bandwidth determination module 306 can determine a bandwidth value for each block of data provided by the social networking system to the computing device.

In some embodiments, the bandwidth determination module 306 can determine a bandwidth value for one or more portions of a block of data. A bandwidth value can be determined for one or more portions of a block of data when the block of data satisfies a threshold block size. The threshold block size can be any suitable value. When a block of data satisfies the threshold block size, a bandwidth value can be determined based on one or more portions of the block of data. Further, the bandwidth value based on one or more portions of the block of data can be determined before the transmission of the entire block of data. In particular, a block of data that satisfies a threshold block size can be partitioned into two or more chunks. The size of each chunk can be determined in a variety of ways. For example, a size of a chunk can be a predetermined size of data (e.g., 10K bytes) selected by an administrator of the social networking system. As another example, a size of a chunk can be based on the total size of a block of data divided by a selected number of chunks desired for the block of data. The bandwidth determination module 306 can determine bandwidth values for one or more chunks of the block of data. A determination of bandwidth values based on a portion of a block of data in this manner can be used to accelerate a prediction of future bandwidth value for another block of data, as described in more detail herein. In some embodiments, historical bandwidth can be based on application-wide or system-wide network counters instead of considering individual data blocks separately. In some embodiments, all the data received can be considered while one or more responses is being received (i.e., the data block starts when any response starts being received, and stops when the number of streams being received drops to zero).

In some embodiments, the determinations of historical bandwidth values can be calculated in whole or in part by the computing device associated with the user in a manner similar to the technique of the bandwidth determination module 306. When the computing device associated with the user calculates bandwidth values, the computing device can transmit the calculated bandwidth values to the bandwidth determination module 306 and the bandwidth determination module 306 need not perform calculations to determine bandwidth values.

The averaging module 308 can receive determinations of historical bandwidth values and calculate an average bandwidth value based on the historical bandwidth values. The averaging module 308 can calculate a moving average where each new calculation of a historical bandwidth value is combined with previous historical bandwidth values to calculate a new average. In some embodiments, the averaging module 308 can calculate a new average based on a threshold number of the most recent historical bandwidth values. The averaging module 308 can calculate an average bandwidth value based on one or more suitable averaging techniques, such as a mean, a median, a mode, etc. For example, the averaging module 308 can calculate a weighted geometric mean.

The averaging module 308 can apply a decay function to historical bandwidth values in the calculation of an average bandwidth value. In some embodiments, the decay function can reduce the weight of historical bandwidth values based on their distance from the most recent bandwidth value that has been determined. In some embodiments, the decay function can be applied to historical bandwidth values that are a threshold time distance from the most recently determined bandwidth value. In some embodiments, the decay function can be applied to historical bandwidth values that are a threshold number of bandwidth determinations away from the most recent bandwidth determination. The decay function can be linear or nonlinear.

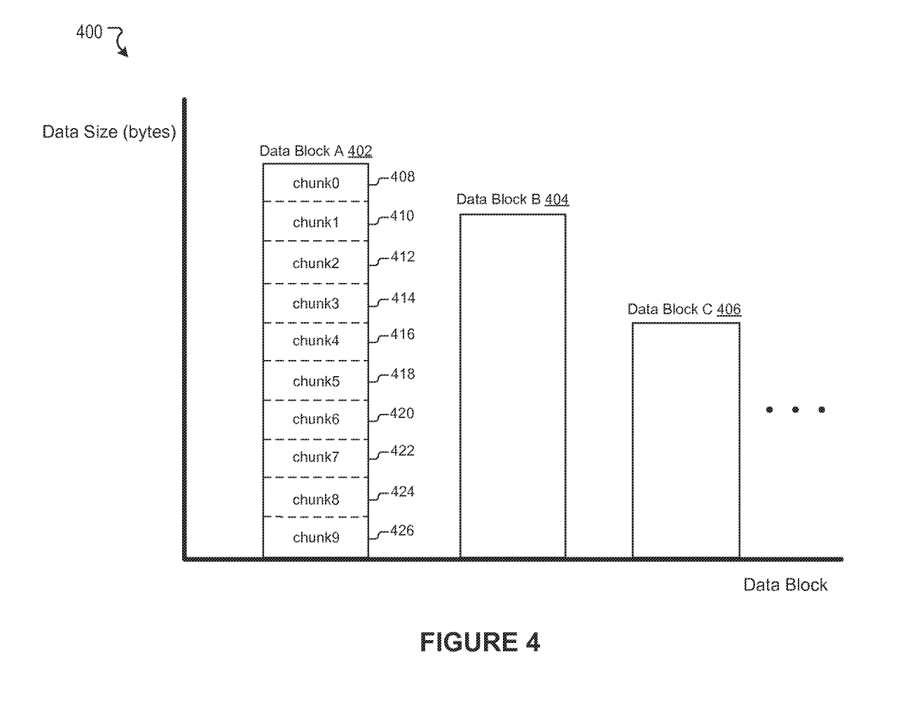

FIG. 4 illustrates an example data transmission 400 from which a bandwidth value can be predicted, according to an embodiment of the present disclosure. The data transmission 400 is reflected on a graph illustrating various blocks of data and their data size. The data transmission 400 includes a data block A 402, a data block B 404, and a data block C 406. In the example shown, the data block A 402 is in the process of transmitting from a social networking system to a computing device associated with a user. The data block A 402 has been divided into ten chunks 408-426 for the purposes of determining a predicted bandwidth value. As shown, each the data chunks 408-426 is of equal data size. The data chunks 408-426 can be sequentially transmitted, starting with chunk0 408, then chunk1 410, then chunk2 412, and so on until the transmission of chunk9 426. The data block B 404 has been selected for transmission from the social networking system to the computing device. The data block C 406 also has been selected for transmission from the social networking system to the computing device.

The connection quality module 102 can calculate an average bandwidth value based on two or more of the chunks of the data block A 402. As transmission time information for each chunk is received, a bandwidth value can be determined for the chunk. The determined bandwidth value for the chunk can be combined with previously determined bandwidth values for previously transmitted chunks to calculate a new average bandwidth value.

For example, with respect to the data transmission 400, the transmission time for chunk0 408 can be determined. The data size of chunk0 408 can be divided by the transmission time for chunk0 408 to determine a bandwidth value based on transmission of chunk0 408. Likewise, the transmission time for chunk1 410 can be determined. The data size of chunk1 410 can be divided by the transmission time for chunk1 410 to determine a bandwidth value based on transmission of chunk1 410. The bandwidth values associated with chunk0 408 and chunk1 410 can be combined to calculate an average bandwidth value. Further, the transmission time for chunk2 412 can be determined. The data size of chunk2 412 can be divided by the transmission time for chunk2 412 to determine a bandwidth value based on transmission of chunk2 412. The bandwidth values associated with chunk0 408, chunk1 410, and chunk2 412 can be combined to calculate a new, updated average. Likewise, bandwidth values for chunks 414-426 can be determined in a similar manner. After each of the bandwidth values for each of the chunks 414-426 is determined, each bandwidth value can be combined with previously determined bandwidth values to calculate a new, updated average bandwidth value. As discussed in more detail herein, other features and functionality, such as the application of threshold size filters or decay functions, can be implemented.

Each calculated average bandwidth value based on successive chunks of a block of data can then be categorized into a connection quality class. The connection quality class can be categorized and used to predict the connection quality for future transmissions of data, such as the data block B 404 and the data block C 406, even before the transmission of the entire data block A 402 has concluded. For example, transmission of the data block A 402 by the social networking system (or receipt of the data block A 402 by a computing device associated with a user) can begin before transmission of the data block B 404 or the data block C 406. Further, transmission of the data block B 404 and the data block C 406 can complete while transmission of the data block A 402 is ongoing. In this manner, an average bandwidth value and its associated connection quality class can be used to quickly determine a predicted bandwidth value for later transmissions of data. Based on the predicted bandwidth value, the social networking system can implement proactive measures in advance of such future transmissions of data to optimize user experience based on the expected connection quality.

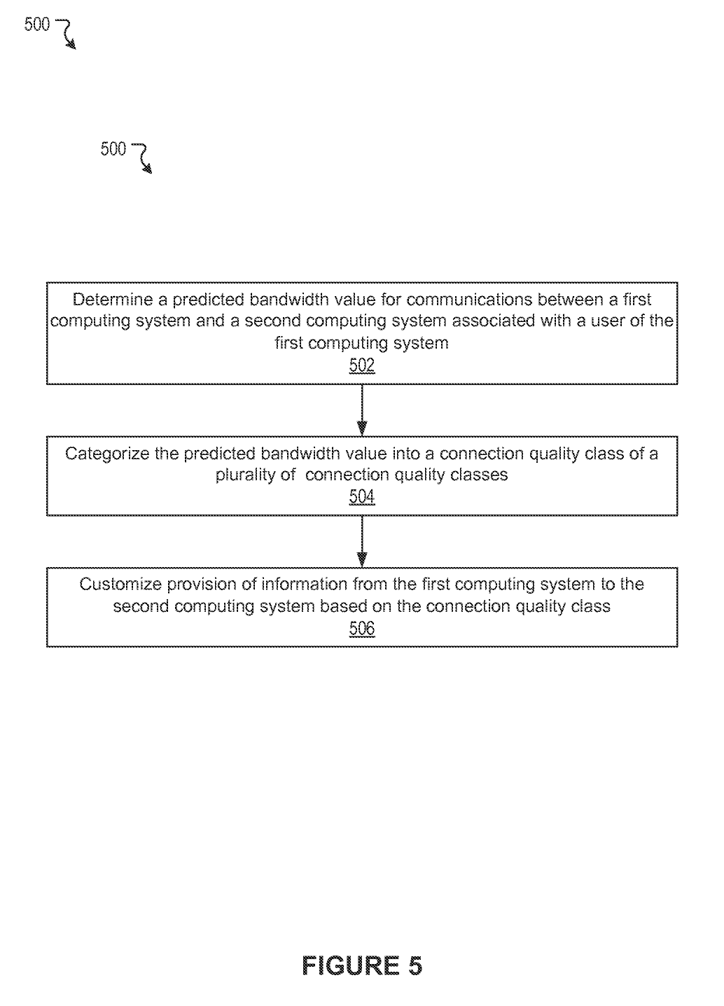

FIG. 5 illustrates an example method 500, according to an embodiment of the present disclosure. It should be appreciated that there can be additional, fewer, or alternative steps performed in similar or alternative orders, or in parallel, within the scope of the various embodiments described herein unless otherwise stated.

At block 502, the method 500 can determine a predicted bandwidth value for communications between a first computing system and a second computing system associated with a user of the first computing system. At block 504, the method 500 can categorize the predicted bandwidth value into a connection quality class of a plurality of connection quality classes. At block 506, the method 500 can customize provision of information from the first computing system to the second computing system based on the connection quality class. Many variations based on features and functionality discussed herein regarding the present disclosure are possible.

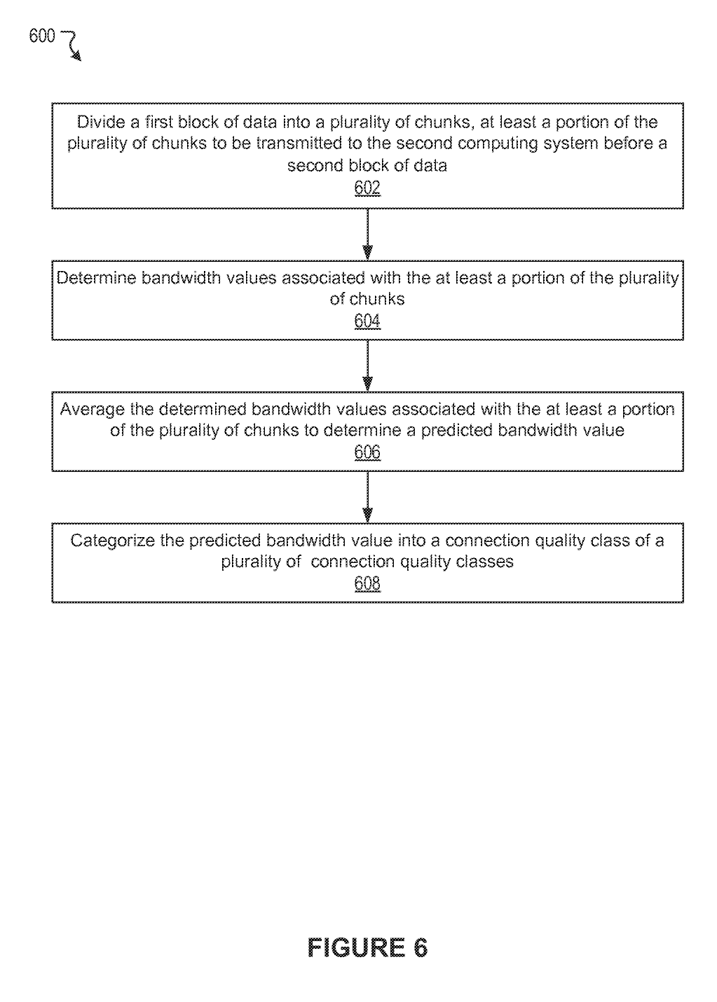

FIG. 6 illustrates an example method 600, according to an embodiment of the present disclosure. It should be appreciated that there can be additional, fewer, or alternative steps performed in similar or alternative orders, or in parallel, within the scope of the various embodiments described herein unless otherwise stated.

At block 602, the method 600 can divide a first block of data into a plurality of chunks, at least a portion of the plurality of chunks to be transmitted to the second computing system before a second block of data. At block 604, the method 600 can determine bandwidth values associated with the at least a portion of the plurality of chunks. At block 606, the method 600 can average the determined bandwidth values associated with the at least a portion of the plurality of chunks to determine a predicted bandwidth value. At block 608, the method 600 can categorize the predicted bandwidth value into a connection quality class of a plurality of connection quality classes. Many variations based on features and functionality discussed herein regarding the present disclosure are possible.

### Social Networking System—Example Implementation

FIG. 7 illustrates a network diagram of an example system 700 that can be utilized in various scenarios, in accordance with an embodiment of the present disclosure. The system 700 includes one or more user devices 710, one or more external systems 720, a social networking system (or service) 730, and a network 750. In an embodiment, the social networking service, provider, and/or system discussed in connection with the embodiments described above may be implemented as the social networking system 730. For purposes of illustration, the embodiment of the system 700, shown by FIG. 7, includes a single external system 720 and a single user device 710. However, in other embodiments, the system 700 may include more user devices 710 and/or more external systems 720. In certain embodiments, the social networking system 730 is operated by a social network provider, whereas the external systems 720 are separate from the social networking system 730 in that they may be operated by different entities. In various embodiments, however, the social networking system 730 and the external systems 720 operate in conjunction to provide social networking services to users (or members) of the social networking system 730. In this sense, the social networking system 730 provides a platform or backbone, which other systems, such as external systems 720, may use to provide social networking services and functionalities to users across the Internet.

The user device 710 comprises one or more computing devices (or systems) that can receive input from a user and transmit and receive data via the network 750. In one embodiment, the user device 710 is a conventional computer system executing, for example, a Microsoft Windows compatible operating system (OS), Apple OS X, and/or a Linux distribution. In another embodiment, the user device 710 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 710 is configured to communicate via the network 750. The user device 710 can execute an application, for example, a browser application that allows a user of the user device 710 to interact with the social networking system 730. In another embodiment, the user device 710 interacts with the social networking system 730 through an application programming interface (API) provided by the native operating system of the user device 710, such as iOS and ANDROID. The user device 710 is configured to communicate with the external system 720 and the social networking system 730 via the network 750, which may comprise any combination of local area and/or wide area networks, using wired and/or wireless communication systems.

In one embodiment, the network 750 uses standard communications technologies and protocols. Thus, the network 750 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 750 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 750 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 710 may display content from the external system 720 and/or from the social networking system 730 by processing a markup language document 714 received from the external system 720 and from the social networking system 730 using a browser application 712. The markup language document 714 identifies content and one or more instructions describing formatting or presentation of the content. By executing the instructions included in the markup language document 714, the browser application 712 displays the identified content using the format or presentation described by the markup language document 714. For example, the markup language document 714 includes instructions for generating and displaying a web page having multiple frames that include text and/or image data retrieved from the external system 720 and the social networking system 730. In various embodiments, the markup language document 714 comprises a data file including extensible markup language (XML) data, extensible hypertext markup language (XHTML) data, or other markup language data. Additionally, the markup language document 714 may include JavaScript Object Notation (JSON) data, JSON with padding (JSONP), and JavaScript data to facilitate data-interchange between the external system 720 and the user device 710. The browser application 712 on the user device 710 may use a JavaScript compiler to decode the markup language document 714.

The markup language document 714 may also include, or link to, applications or application frameworks such as FLASH™ or Unity™ applications, the Silverlight™ application framework, etc.

In one embodiment, the user device 710 also includes one or more cookies 716 including data indicating whether a user of the user device 710 is logged into the social networking system 730, which may enable modification of the data communicated from the social networking system 730 to the user device 710.

The external system 720 includes one or more web servers that include one or more web pages 722a, 722b, which are communicated to the user device 710 using the network 750. The external system 720 is separate from the social networking system 730. For example, the external system 720 is associated with a first domain, while the social networking system 730 is associated with a separate social networking domain. Web pages 722a, 722b, included in the external system 720, comprise markup language documents 714 identifying content and including instructions specifying formatting or presentation of the identified content.

The social networking system 730 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 730 may be administered, managed, or controlled by an operator. The operator of the social networking system 730 may be a human being, an automated application, or a series of applications for managing content, regulating policies, and collecting usage metrics within the social networking system 730. Any type of operator may be used.

Users may join the social networking system 730 and then add connections to any number of other users of the social networking system 730 to whom they desire to be connected. As used herein, the term “friend” refers to any other user of the social networking system 730 to whom a user has formed a connection, association, or relationship via the social networking system 730. For example, in an embodiment, if users in the social networking system 730 are represented as nodes in the social graph, the term “friend” can refer to an edge formed between and directly connecting two user nodes.

Connections may be added explicitly by a user or may be automatically created by the social networking system 730 based on common characteristics of the users (e.g., users who are alumni of the same educational institution). For example, a first user specifically selects a particular other user to be a friend. Connections in the social networking system 730 are usually in both directions, but need not be, so the terms “user” and “friend” depend on the frame of reference. Connections between users of the social networking system 730 are usually bilateral (“two-way”), or “mutual,” but connections may also be unilateral, or “one-way.” For example, if Bob and Joe are both users of the social networking system 730 and connected to each other, Bob and Joe are each other's connections. If, on the other hand, Bob wishes to connect to Joe to view data communicated to the social networking system 730 by Joe, but Joe does not wish to form a mutual connection, a unilateral connection may be established. The connection between users may be a direct connection; however, some embodiments of the social networking system 730 allow the connection to be indirect via one or more levels of connections or degrees of separation.

In addition to establishing and maintaining connections between users and allowing interactions between users, the social networking system 730 provides users with the ability to take actions on various types of items supported by the social networking system 730. These items may include groups or networks (i.e., social networks of people, entities, and concepts) to which users of the social networking system 730 may belong, events or calendar entries in which a user might be interested, computer-based applications that a user may use via the social networking system 730, transactions that allow users to buy or sell items via services provided by or through the social networking system 730, and interactions with advertisements that a user may perform on or off the social networking system 730. These are just a few examples of the items upon which a user may act on the social networking system 730, and many others are possible. A user may interact with anything that is capable of being represented in the social networking system 730 or in the external system 720, separate from the social networking system 730, or coupled to the social networking system 730 via the network 750.

The social networking system 730 is also capable of linking a variety of entities. For example, the social networking system 730 enables users to interact with each other as well as external systems 720 or other entities through an API, a web service, or other communication channels. The social networking system 730 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 730. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 730 modifies edges connecting the various nodes to reflect the relationships and interactions.

The social networking system 730 also includes user-generated content, which enhances a user's interactions with the social networking system 730. User-generated content may include anything a user can add, upload, send, or “post” to the social networking system 730. For example, a user communicates posts to the social networking system 730 from a user device 710. Posts may include data such as status updates or other textual data, location information, images such as photos, videos, links, music or other similar data and/or media. Content may also be added to the social networking system 730 by a third party. Content “items” are represented as objects in the social networking system 730. In this way, users of the social networking system 730 are encouraged to communicate with each other by posting text and content items of various types of media through various communication channels. Such communication increases the interaction of users with each other and increases the frequency with which users interact with the social networking system 730.

The social networking system 730 includes a web server 732, an API request server 734, a user profile store 736, a connection store 738, an action logger 740, an activity log 742, and an authorization server 744. In an embodiment of the invention, the social networking system 730 may include additional, fewer, or different components for various applications. Other components, such as network interfaces, security mechanisms, load balancers, failover servers, management and network operations consoles, and the like are not shown so as to not obscure the details of the system.

The user profile store 736 maintains information about user accounts, including biographic, demographic, and other types of descriptive information, such as work experience, educational history, hobbies or preferences, location, and the like that has been declared by users or inferred by the social networking system 730. This information is stored in the user profile store 736 such that each user is uniquely identified. The social networking system 730 also stores data describing one or more connections between different users in the connection store 738. The connection information may indicate users who have similar or common work experience, group memberships, hobbies, or educational history. Additionally, the social networking system 730 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 730, such as non-person entities, buckets, cluster centers, images, interests, pages, external systems, concepts, and the like are also stored in the connection store 738.

The social networking system 730 maintains data about objects with which a user may interact. To maintain this data, the user profile store 736 and the connection store 738 store instances of the corresponding type of objects maintained by the social networking system 730. Each object type has information fields that are suitable for storing information appropriate to the type of object. For example, the user profile store 736 contains data structures with fields suitable for describing a user's account and information related to a user's account. When a new object of a particular type is created, the social networking system 730 initializes a new data structure of the corresponding type, assigns a unique object identifier to it, and begins to add data to the object as needed. This might occur, for example, when a user becomes a user of the social networking system 730, the social networking system 730 generates a new instance of a user profile in the user profile store 736, assigns a unique identifier to the user account, and begins to populate the fields of the user account with information provided by the user.

The connection store 738 includes data structures suitable for describing a user's connections to other users, connections to external systems 720 or connections to other entities. The connection store 738 may also associate a connection type with a user's connections, which may be used in conjunction with the user's privacy setting to regulate access to information about the user. In an embodiment of the invention, the user profile store 736 and the connection store 738 may be implemented as a federated database.

Data stored in the connection store 738, the user profile store 736, and the activity log 742 enables the social networking system 730 to generate the social graph that uses nodes to identify various objects and edges connecting nodes to identify relationships between different objects. For example, if a first user establishes a connection with a second user in the social networking system 730, user accounts of the first user and the second user from the user profile store 736 may act as nodes in the social graph. The connection between the first user and the second user stored by the connection store 738 is an edge between the nodes associated with the first user and the second user. Continuing this example, the second user may then send the first user a message within the social networking system 730. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 730 (or, alternatively, in an image maintained by another system outside of the social networking system 730). The image may itself be represented as a node in the social networking system 730. This tagging action may create edges between the first user and the second user as well as create an edge between each of the users and the image, which is also a node in the social graph. In yet another example, if a user confirms attending an event, the user and the event are nodes obtained from the user profile store 736, where the attendance of the event is an edge between the nodes that may be retrieved from the activity log 742. By generating and maintaining the social graph, the social networking system 730 includes data describing many different types of objects and the interactions and connections among those objects, providing a rich source of socially relevant information.

The web server 732 links the social networking system 730 to one or more user devices 710 and/or one or more external systems 720 via the network 750. The web server 732 serves web pages, as well as other web-related content, such as Java, JavaScript, Flash, XML, and so forth. The web server 732 may include a mail server or other messaging functionality for receiving and routing messages between the social networking system 730 and one or more user devices 710. The messages can be instant messages, queued messages (e.g., email), text and SMS messages, or any other suitable messaging format.

The API request server 734 allows one or more external systems 720 and user devices 710 to call access information from the social networking system 730 by calling one or more API functions. The API request server 734 may also allow external systems 720 to send information to the social networking system 730 by calling APIs. The external system 720, in one embodiment, sends an API request to the social networking system 730 via the network 750, and the API request server 734 receives the API request. The API request server 734 processes the request by calling an API associated with the API request to generate an appropriate response, which the API request server 734 communicates to the external system 720 via the network 750. For example, responsive to an API request, the API request server 734 collects data associated with a user, such as the user's connections that have logged into the external system 720, and communicates the collected data to the external system 720. In another embodiment, the user device 710 communicates with the social networking system 730 via APIs in the same manner as external systems 720.

The action logger 740 is capable of receiving communications from the web server 732 about user actions on and/or off the social networking system 730. The action logger 740 populates the activity log 742 with information about user actions, enabling the social networking system 730 to discover various actions taken by its users within the social networking system 730 and outside of the social networking system 730. Any action that a particular user takes with respect to another node on the social networking system 730 may be associated with each user's account, through information maintained in the activity log 742 or in a similar database or other data repository. Examples of actions taken by a user within the social networking system 730 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 730, the action is recorded in the activity log 742. In one embodiment, the social networking system 730 maintains the activity log 742 as a database of entries. When an action is taken within the social networking system 730, an entry for the action is added to the activity log 742. The activity log 742 may be referred to as an action log.

Additionally, user actions may be associated with concepts and actions that occur within an entity outside of the social networking system 730, such as an external system 720 that is separate from the social networking system 730. For example, the action logger 740 may receive data describing a user's interaction with an external system 720 from the web server 732. In this example, the external system 720 reports a user's interaction according to structured actions and objects in the social graph.

Other examples of actions where a user interacts with an external system 720 include a user expressing an interest in an external system 720 or another entity, a user posting a comment to the social networking system 730 that discusses an external system 720 or a web page 722a within the external system 720, a user posting to the social networking system 730 a Uniform Resource Locator (URL) or other identifier associated with an external system 720, a user attending an event associated with an external system 720, or any other action by a user that is related to an external system 720. Thus, the activity log 742 may include actions describing interactions between a user of the social networking system 730 and an external system 720 that is separate from the social networking system 730.

The authorization server 744 enforces one or more privacy settings of the users of the social networking system 730. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 720, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 720. One embodiment allows the specification of the set of entities to comprise an enumeration of entities. For example, the user may provide a list of external systems 720 that are allowed to access certain information. Another embodiment allows the specification to comprise a set of entities along with exceptions that are not allowed to access the information. For example, a user may allow all external systems 720 to access the user's work information, but specify a list of external systems 720 that are not allowed to access the work information. Certain embodiments call the list of exceptions that are not allowed to access certain information a “block list”. External systems 720 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 744 contains logic to determine if certain information associated with a user can be accessed by a user's friends, external systems 720, and/or other applications and entities. The external system 720 may need authorization from the authorization server 744 to access the user's more private and sensitive information, such as the user's work phone number. Based on the user's privacy settings, the authorization server 744 determines if another user, the external system 720, an application, or another entity is allowed to access information associated with the user, including information about actions taken by the user.

In some embodiments, the social networking system 730 can include a connection quality module 746. The connection quality module 746 can, for example, be implemented as the connection quality module 102 of FIG. 1. As discussed previously, it should be appreciated that there can be many variations or other possibilities. For example, in some instances, the connection quality module 746 (or at least a portion thereof) can be included in the user device 710. Other features of the connection quality module 746 are discussed herein in connection with the connection quality module 102.

### Hardware Implementation

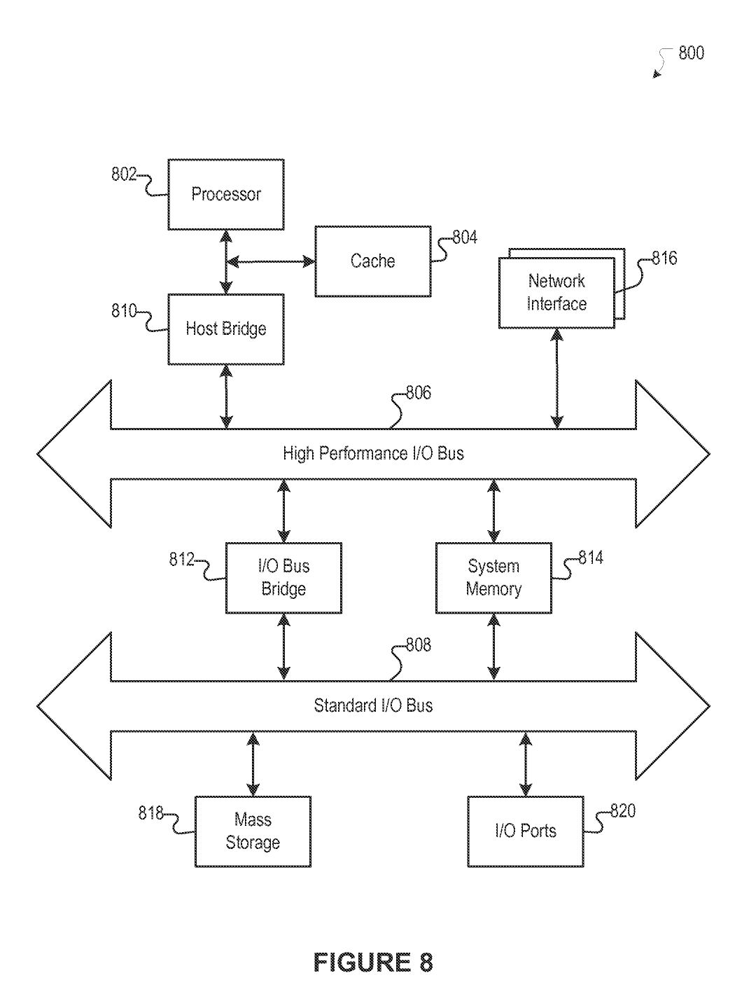

The foregoing processes and features can be implemented by a wide variety of machine and computer system architectures and in a wide variety of network and computing environments. FIG. 8 illustrates an example of a computer system 800 that may be used to implement one or more of the embodiments described herein in accordance with an embodiment of the invention. The computer system 800 includes sets of instructions for causing the computer system 800 to perform the processes and features discussed herein. The computer system 800 may be connected (e.g., networked) to other machines. In a networked deployment, the computer system 800 may operate in the capacity of a server machine or a client machine in a client-server network environment, or as a peer machine in a peer-to-peer (or distributed) network environment. In an embodiment of the invention, the computer system 800 may be the social networking system 730, the user device 710, and the external system 820, or a component thereof. In an embodiment of the invention, the computer system 800 may be one server among many that constitutes all or part of the social networking system 730.

The computer system 800 includes a processor 802, a cache 804, and one or more executable modules and drivers, stored on a computer-readable medium, directed to the processes and features described herein. Additionally, the computer system 800 includes a high performance input/output (I/O) bus 806 and a standard I/O bus 808. A host bridge 810 couples processor 802 to high performance I/O bus 806, whereas I/O bus bridge 812 couples the two buses 806 and 808 to each other. A system memory 814 and one or more network interfaces 816 couple to high performance I/O bus 806. The computer system 800 may further include video memory and a display device coupled to the video memory (not shown). Mass storage 818 and I/O ports 820 couple to the standard I/O bus 808. The computer system 800 may optionally include a keyboard and pointing device, a display device, or other input/output devices (not shown) coupled to the standard I/O bus 808. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 800, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 800 are described in greater detail below. In particular, the network interface 816 provides communication between the computer system 800 and any of a wide range of networks, such as an Ethernet (e.g., IEEE 802.3) network, a backplane, etc. The mass storage 818 provides permanent storage for the data and programming instructions to perform the above-described processes and features implemented by the respective computing systems identified above, whereas the system memory 814 (e.g., DRAM) provides temporary storage for the data and programming instructions when executed by the processor 802. The I/O ports 820 may be one or more serial and/or parallel communication ports that provide communication between additional peripheral devices, which may be coupled to the computer system 800.

The computer system 800 may include a variety of system architectures, and various components of the computer system 800 may be rearranged. For example, the cache 804 may be on-chip with processor 802. Alternatively, the cache 804 and the processor 802 may be packed together as a “processor module”, with processor 802 being referred to as the “processor core”. Furthermore, certain embodiments of the invention may neither require nor include all of the above components. For example, peripheral devices coupled to the standard I/O bus 808 may couple to the high performance I/O bus 806. In addition, in some embodiments, only a single bus may exist, with the components of the computer system 800 being coupled to the single bus. Moreover, the computer system 800 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 800 that, when read and executed by one or more processors, cause the computer system 800 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 800, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 802. Initially, the series of instructions may be stored on a storage device, such as the mass storage 818. However, the series of instructions can be stored on any suitable computer readable storage medium. Furthermore, the series of instructions need not be stored locally, and could be received from a remote storage device, such as a server on a network, via the network interface 816. The instructions are copied from the storage device, such as the mass storage 818, into the system memory 814 and then accessed and executed by the processor 802. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 800 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a first computing system, a predicted bandwidth value for communications between the first computing system and a second computing system associated with a user of the first computing system;
categorizing, by the first computing system, the predicted bandwidth value into a connection quality class of a plurality of connection quality classes; and
customizing, by the first computing system, provision of information from the first computing system to the second computing system based on the connection quality class.

2. The computer-implemented method of claim 1, wherein the determining a predicted bandwidth value for communications further comprises:
dividing a first block of data into a plurality of chunks, at least a portion of the plurality of chunks to be transmitted to the second computing system before a second block of data;
determining bandwidth values associated with the at least a portion of the plurality of chunks; and
averaging the determined bandwidth values associated with the at least a portion of the plurality of chunks to determine the predicted bandwidth value.

3. The computer-implemented method of claim 2, wherein the categorizing the predicted bandwidth value is performed before transmission of the second block of data.

4. The computer-implemented method of claim 1, wherein the determining a predicted bandwidth value for communications further comprises:
identifying at least one block of data transmitted between the first computing device and the second computing device;
determining bandwidth values associated with the at least one block of data; and
averaging the determined bandwidth values associated with the at least one block of data to determine the predicted bandwidth value.

5. The computer-implemented method of claim 4, wherein the determining a predicted bandwidth value for communications further comprises:
discarding a block of data that does not satisfy a threshold data size before the averaging the determined bandwidth values.

6. The computer-implemented method of claim 4, wherein the determining a predicted bandwidth value for communications further comprises:
applying a decay function to at least one determined bandwidth value before the averaging the determined bandwidth values.

7. The computer-implemented method of claim 1, wherein the determining a predicted bandwidth value for communications comprises:
creating a latency mapping between round trip time associated with the first computing system and the second computing system and historical bandwidth values; and
determining the predicted bandwidth value based on the latency mapping.

8. The computer-implemented method of claim 1, wherein the determining a predicted bandwidth value for communications comprises:
creating a radio mapping between at least one type of communication link associated with communications between the first computing system and the second computing system and historical bandwidth values; and
determining the predicted bandwidth value based on the radio mapping.

9. The computer-implemented method of claim 1, wherein each connection quality class of the plurality of connection quality classes is associated with a unique range of bandwidth values.

10. The computer-implemented method of claim 1, wherein the first computing system is associated with a social networking system and the second computing system is associated with a user of the social networking system.

11. A system comprising:
at least one processor; and
a memory storing instructions that, when executed by the at least one processor, cause the system to perform:
determining a predicted bandwidth value for communications between the first computing system and a second computing system associated with a user of the first computing system;
categorizing the predicted bandwidth value into a connection quality class of a plurality of connection quality classes; and
customizing provision of information from the first computing system to the second computing system based on the connection quality class.

12. The system of claim 11, wherein the determining a predicted bandwidth value for communications further comprises:
dividing a first block of data into a plurality of chunks, at least a portion of the plurality of chunks to be transmitted to the second computing system before a second block of data;
determining bandwidth values associated with the at least a portion of the plurality of chunks; and
averaging the determined bandwidth values associated with the at least a portion of the plurality of chunks to determine the predicted bandwidth value.

13. The system of claim 12, wherein the categorizing the predicted bandwidth value is performed before transmission of the second block of data.

14. The system of claim 11, wherein the determining a predicted bandwidth value for communications further comprises:
identifying at least one block of data transmitted between the first computing device and the second computing device;
determining bandwidth values associated with the at least one block of data; and
averaging the determined bandwidth values associated with the at least one block of data to determine the predicted bandwidth value.

15. The system of claim 14, wherein the determining a predicted bandwidth value for communications further comprises:
discarding a block of data that does not satisfy a threshold data size before the averaging the determined bandwidth values.

16. A non-transitory computer-readable storage medium including instructions that, when executed by at least one processor of a computing system, cause the computing system to perform:
determining a predicted bandwidth value for communications between the first computing system and a second computing system associated with a user of the first computing system;
categorizing the predicted bandwidth value into a connection quality class of a plurality of connection quality classes; and
customizing provision of information from the first computing system to the second computing system based on the connection quality class.

17. The non-transitory computer-readable storage medium of claim 16, wherein the determining a predicted bandwidth value for communications further comprises:
dividing a first block of data into a plurality of chunks, at least a portion of the plurality of chunks to be transmitted to the second computing system before a second block of data;
determining bandwidth values associated with the at least a portion of the plurality of chunks; and
averaging the determined bandwidth values associated with the at least a portion of the plurality of chunks to determine the predicted bandwidth value.

18. The non-transitory computer-readable storage medium of claim 17, wherein the categorizing the predicted bandwidth value is performed before transmission of the second block of data.

19. The non-transitory computer-readable storage medium of claim 16, wherein the determining a predicted bandwidth value for communications further comprises:
identifying at least one block of data transmitted between the first computing device and the second computing device;
determining bandwidth values associated with the at least one block of data; and
averaging the determined bandwidth values associated with the at least one block of data to determine the predicted bandwidth value.

20. The non-transitory computer-readable storage medium of claim 19, wherein the determining a predicted bandwidth value for communications further comprises:
discarding a block of data that does not satisfy a threshold data size before the averaging the determined bandwidth values.
